(19) United States
(12) Patent Application Publication
(10) Pub. No.: US 2026/0267075 A1
(43) Pub. Date: Sep. 10, 2026

(54) OPTICAL INTEGRATED CIRCUIT WITH ENCAPSULATED EDGE COUPLER

(71) Applicant: PHIX B.V., Enschede (NL)

(72) Inventors: Bradley William SNYDER, Enschede (NL); Adriano Ricardo DO NASCIMENTO JÚNIOR, Enschede (NL)

(73) Assignee: PHIX B.V., Enschede (NL)

(21) Appl. No.: 18/871,717

(22) PCT Filed: Jun. 15, 2023
(86) PCT No.: PCT/NL2023/050336

§ 371 Date: Dec. 4, 2024

(30) Foreign Application Priority Data
Jun. 15, 2022 (NL) 2032178

(51) Int. Cl. G02B 6/30; G02B 6/26; G02B 6/36

(52) U.S. Cl. CPC G02B 6/305; G02B 6/262; G02B 6/3684

(57) ABSTRACT

An optical integrated circuit for edge coupling and method of producing thereof. The optical integrated circuit includes a substrate, a top layer arranged on the substrate includes a waveguide and an edge-coupler arranged on the substrate. The edge-coupler includes an optical membrane extending above a cavity in the substrate. The edge-coupler is configured for optically coupling the waveguide to an external optical element. A mechanical support is attached at an end thereof to the substrate either directly or indirectly via the top layer, and is attached at an opposing end to the optical membrane. The edge coupler, the substrate, and the mechanical support jointly form a flat surface for edge coupling to the external optical element.

### FIELD OF INVENTION

The present invention relates to optical integrated circuits with an encapsulated edge coupler, and a method for fabricating such optical integrated circuits.

### BACKGROUND

The two common methods for getting light in and out of an optical integrated circuit are via grating couplers for surface coupling and edge couplers for edge coupling, also referred to as end-fire coupling or butt coupling. While grating couplers provide a solution for coupling light in and out from any location on the chip, their bandwidth can be limited. Edge couplers require additional cleaving and polishing process to create the coupling facet, but they have the advantage of offering a large operating bandwidth and lower losses. An edge coupler is then typically used to couple light between a waveguide on a photonic chip and an external optical element, for instance an optical fiber. An edge coupler typically adapts the spot size between the integrated waveguide and the external element using different possible techniques. To avoid losing light to the substrate when increasing the spot size, the edge coupler typically comprise a membrane structure suspended above a recess in the substrate. A membrane is yet fragile and due to its cantilever arrangement difficult to polish. Cleaving and polishing processes of optical membranes are thus sensitive operations, reducing the yield of production of edge couplers.

US2021/0405298 discloses structures and methods including a waveguide having a cladding layer surrounding a core layer disposed over a substrate, a cavity extending into the substrate adjacent the waveguide, a fiber disposed in the cavity, and an isolation space extending into the substrate and disposed under the waveguide. A plurality of holes may extend through the cladding layer adjacent the core layer.

U.S. Pat. No. 11,221,447 discloses cantilevered waveguides suspended above an air cavity in an underlying substrate. The waveguide is formed by patterning a waveguide layer in some embodiments, and the air cavity is formed by etching the substrate beneath the waveguide. The topside of the air cavity may be sealed by filling the openings used to etch the cavity with a sealant, such as optical epoxy. In some embodiments, the waveguide is a facet coupler, positioned at a chip facet.

### SUMMARY

The object of the invention is to provide an optical integrated circuit for edge coupling and a method of production thereof which overcomes the above-mentioned drawbacks of the prior art, and in particular which simplifies the production and increases the yield of the production of such optical integrated circuits.

According to an aspect of the invention, an optical integrated circuit for edge coupling is provided, comprising a substrate, a top layer arranged on the substrate comprising a waveguide, an edge-coupler arranged on the substrate, and a mechanical support. The edge coupler comprises an optical membrane extending above a cavity in the substrate and is configured for optically coupling the waveguide to an external optical element. The mechanical support is fixedly attached at an end thereof to the substrate directly or indirectly via the top layer and attached at an opposing end thereof to the optical membrane. The edge coupler, the substrate, and the mechanical support jointly form a flat surface configured for edge coupling to the external optical element. In this way, the mechanical support supports mechanically the optical membrane to enable polishing processes and the obtention of a flat surface for edge coupling. The flat surface of the edge coupler, the substrate and the mechanical support acts as coupling facet. By optical integrated circuit is meant a photonic integrated circuit (PIC) incorporating one or more optical functions on a substrate, typically a photonic integrated chip built on a substrate. By edge-coupler is meant an element configured to couple light between a waveguide on an integrated circuit substrate to an external optical element via a coupling facet.

According to a preferred embodiment, the mechanical support is fixedly attached directly or indirectly to the substrate and to the optical membrane through at least one adhesive. In this way, the mechanical strength of the assembly comprising the optical membrane, the substrate and the mechanical support can be improved. The membrane, despite being extending above a cavity in the substrate, may be attached rigidly to the substrate via the mechanical support and the adhesive.

According to a preferred embodiment, the at least one adhesive comprises an optical adhesive and optionally a structural adhesive. In this way, the same adhesive or two different adhesives may be used based on their optical properties and/or their structural (mechanical) properties. In particular the optical adhesive may be used to fixedly attach the mechanical support to the optical membrane and have optical properties compatible with the operation of the optical membrane. A structural adhesive may be used to fixedly attach the mechanical support directly or indirectly with the substrate via the top layer and as such its optical properties may be indifferent.

According to a preferred embodiment, the mechanical support is fixedly attached to the optical membrane through an optical adhesive, wherein the optical membrane comprises an edge-coupling waveguide and cladding surrounding the edge-coupling waveguide, wherein the effective refractive index of the optical adhesive is equal or smaller than an effective refractive index of the cladding of the edge coupler. In this way, light is not lost into the optical adhesive and an efficient edge-coupling may be achieved.

According to a preferred embodiment, the optical adhesive is arranged on top of the at least one optical membrane and/or in at least one cavity under the at least one optical membrane and/or surrounding the at least one optical membrane. If the optical adhesive is arranged on the top of the at least one optical membrane, light is prevented from leaking above the optical membrane and the mechanical support may be fixedly attached over the whole upper surface of the optical membrane. If the optical adhesive is further arranged in at the at least one cavity, the optical membrane may be on the one hand supported from under the cantilevered structure, improving the rigidity of the optical membrane and on the other hand, it may avoid polishing debris to enter the at least one cavity.

According to a preferred embodiment, the optical membrane is any one of the following: a spot-size converter for connecting a waveguide in the optical integrated circuit with an external optical element, a sensing membrane. In this way the edge coupler may perform a spot size changing function or a sensing function. A spot-size converter typically couples light from a strongly confined waveguide into an optical element, typically an optical fiber, having a much large mode field size.

According to a preferred embodiment, the optical membrane comprises a tapered waveguide coupled to the waveguide of the top layer. In this way the mode field size may be adjusted.

According to a preferred embodiment, the waveguide is a channel waveguide, preferably the waveguide is any one of the following: a buried waveguide, a diffused waveguide, a wire waveguide, a strip loaded waveguide, an arrow waveguide, a rib waveguide, a slot waveguide, a metamaterial waveguide. The edge-coupling waveguide of the optical membrane may similarly be of any one of the above-mentioned types.

According to a preferred embodiment, the substrate is made of one of the following: a photo-sensitive substrate or a semiconductor wafer, preferably the substrate is made of one of the following: a polymer substrate, a glass substrate, a silicon wafer, silicon dioxide wafer, a lithium niobate wafer, a Gallium Arsenide wafer or an indium phosphide wafer, a ceramic substrate, a fiberglass substrate, an organic substrate.

According to a preferred embodiment, the optical membrane is made of one of the following: a Si/SiN waveguide in a SiO2 cladding, doped SiO2 waveguide in a SiO2 cladding, polymer waveguide in a polymer cladding, waveguide and cladding composed of a binary combination of materials from Groups III and V of the periodic table, waveguide and cladding composed of a ternary combination of materials from Groups III and V of the periodic table, waveguide and cladding composed of a quaternary combination of materials from Groups III and V of the periodic table, or other materials supporting a high-index-contrast waveguide.

According to a preferred embodiment, the mechanical support is made of one of the following: glass, silicon, polymer, ceramic, fiberglass, a binary combination of materials from Groups III and V of the periodic table, a ternary combination of materials from Groups III and V of the periodic table, a quaternary combination of materials from Groups III and V of the periodic table, or another mechanically compatible material. In this way, a rigid mechanical support is provided.

According to another aspect, a method is provided for producing an optical integrated circuit for edge coupling, the method comprising:
providing an assembly with a substrate, a top layer arranged on the substrate comprising a waveguide and an edge-coupler arranged on the substrate, the edge coupler being configured for optically coupling the waveguide to an external optical element and comprising an optical membrane extending above a cavity in the substrate,
fixedly attaching a mechanical support at an end thereof to the substrate directly or indirectly via the top layer and at an opposing end thereof to the optical membrane,
post-processing such that the optical membrane, the substrate, and the mechanical support jointly form a flat surface configured for edge coupling with the external optical element.

In this way, the post-processing to obtain a flat surface for edge-coupling may be simplified, since the mechanical support supports the optical membrane. The yield of the production method may in return be increased since the optical membrane is protected during the post-processing by its attachment to the mechanical support.

According to a preferred embodiment, providing an assembly with a substrate, a waveguide and an edge-coupler comprises etching at least one cavity in the substrate under an edge coupler portion, to obtain an optical membrane at least partially extending above the at least one cavity in the substrate. In this way, light may be prevented from getting lost in the substrate as the mode size changes in the edge coupler portion.

According to a preferred embodiment, fixedly attaching a mechanical support comprises dispensing an optical adhesive and placing the mechanical support above the optical adhesive, and optionally curing the optical adhesive. In this way, the optical adhesive may avoid losing light above the optical membrane. Preferably dispensing an optical adhesive comprises dispensing the optical adhesive on top of the optical membrane and/or on the top layer and/or in the at least one cavity and/or surrounding the at least one optical membrane. In this way, the optical adhesive may prevent losing light in the cavity, and/or in the substrate. The optical adhesive, when dispensed in the cavity, may be used as a filler avoiding post-processing debris to enter the cavity. In other words the optical adhesive may be dispensed to fill the entire cavity.

According to a preferred embodiment, fixedly attaching a mechanical support comprises dispensing a structural adhesive in the remaining gap between the mechanical support and the top layer, and optionally curing the structural adhesive. In this way, cost may be limited, by using an adhesive which optical properties would not matter.

According to a preferred embodiment, post-processing comprises dicing to obtain two integrated circuits. In this way, an improving dicing process can be achieved.

According to a preferred embodiment, post-processing comprises preferably cutting off the excess of optical adhesive up to an edge of the mechanical support and/or an edge of the substrate. In this way, a first facet may be easily obtained.

According to a preferred embodiment, post-processing further comprises grinding and/or polishing an edge of the optical integrated circuit obtained at the previous step, up to an edge of the optical membrane to obtain a flat edge surface for edge coupling the optical integrated circuit with an external optical element. In this way, grinding and/or polishing efforts may be applied without damaging the optical membrane.

This and other aspects of the present invention will now be described in more detail, with reference to the appended drawings showing currently preferred embodiments of the invention, wherein:

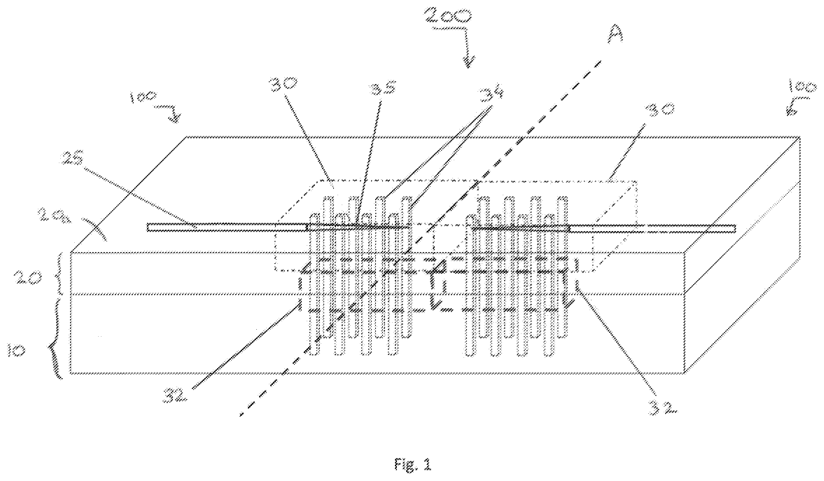

FIG. 1 illustrates a perspective view of an optical integrated circuit comprising two integrated edge couplers according to the prior art.

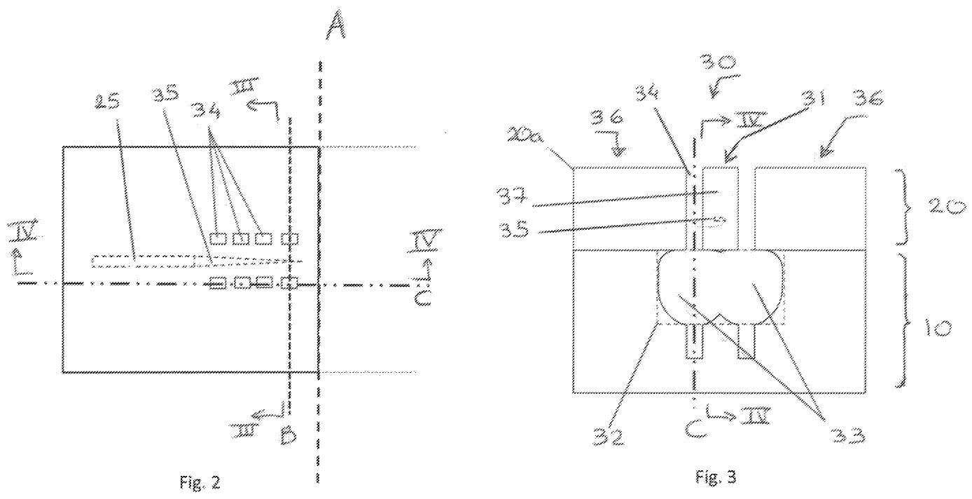

FIG. 2 illustrates a schematic top view of half of the optical integrated circuit of FIG. 2.

FIG. 3 illustrates a schematic cross section of the optical integrated circuit of FIG. 2 along a direction marked in FIGS. 2 and 3.

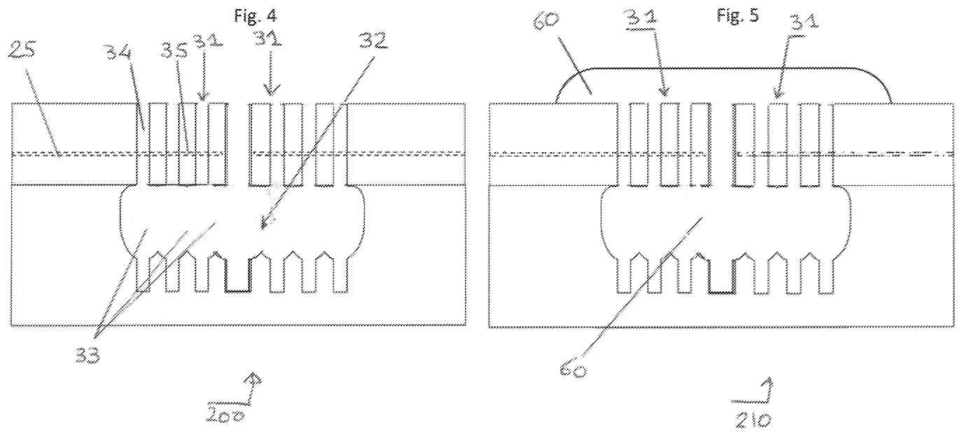

FIG. 4 illustrates a cross section view of the optical integrated circuit of FIG. 2 along a plane perpendicular to the section plane of FIG. 4 according to a first step of a method according to an embodiment of the present invention.

FIGS. 5-7 illustrate cross section views during subsequent steps of a method according to an embodiment of the present invention.

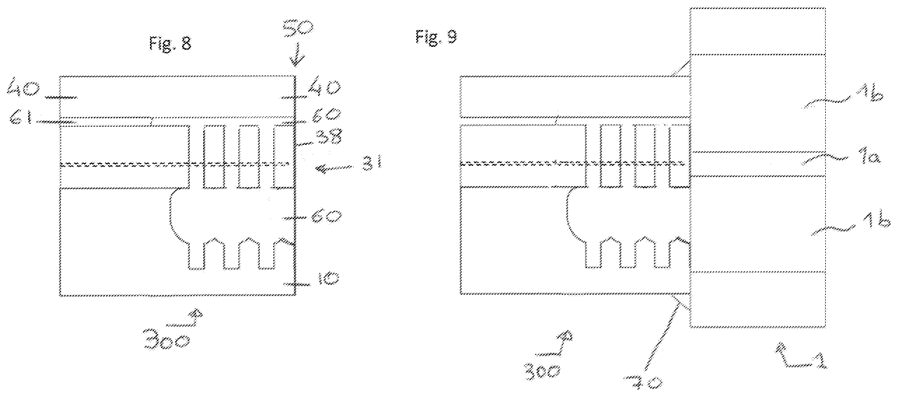

FIG. 8 illustrate a cross section view of an optical integrated circuit according to an embodiment.

FIG. 9 illustrate a cross section of an optical integral circuit according to FIG. 9 coupled to an optical fiber.

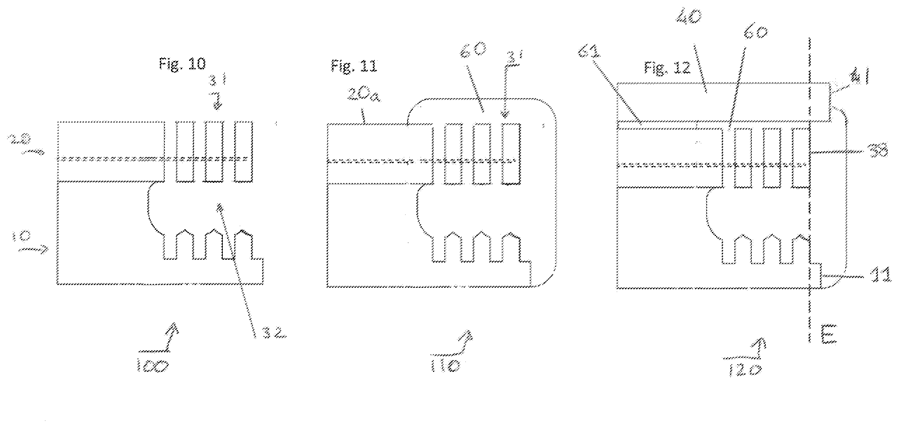

FIG. 10 illustrates a flow chart representing the steps of a method according to an embodiment of the present invention.

FIGS. 11 and 12 illustrate flow charts representing some further steps of a method according to additional embodiments of the present invention.

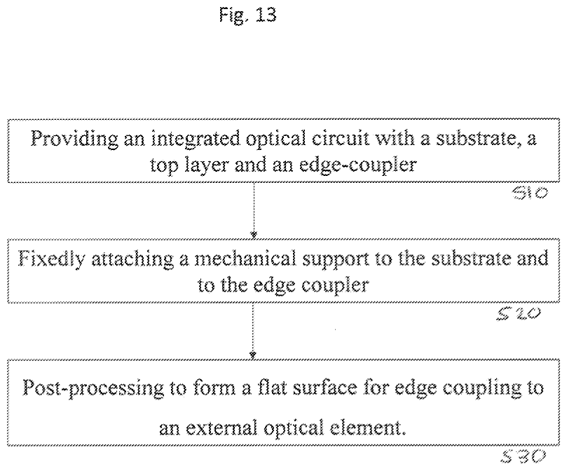

FIG. 13 illustrate a cross section of an assembly used at the start of a method according to another embodiment of the present invention.

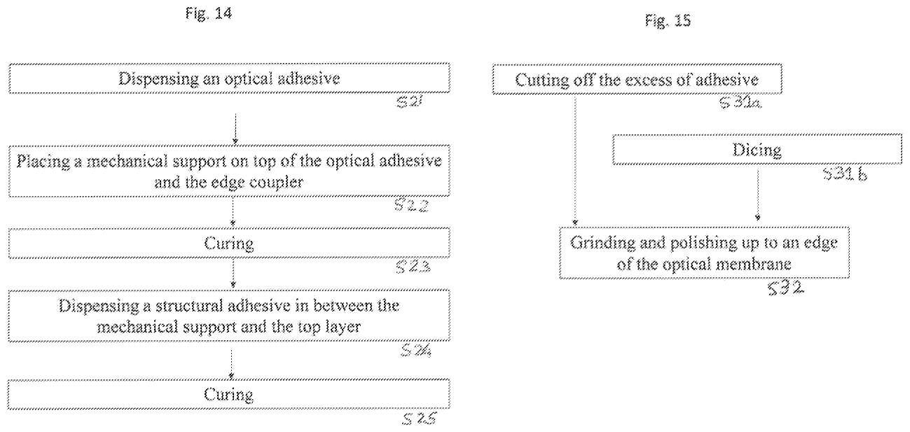

FIGS. 14-15 cross section views during subsequent steps of a method according to an embodiment of the present invention when starting from FIG. 13.

FIG. 1 illustrates a perspective view of an optical integrated circuit 200 comprising two integrated edge couplers 30 according to the prior art illustrated in FIG. 1. The optical integrated circuit 200 of FIG. 2 is meant to be diced along a dicing direction A. After dicing, two separate optical integrated circuits 100 may be obtained. The edge couplers 30 are meant for edge coupling via a coupling facet to an external optical element (not represented), in particular an optical fiber. Each optical integrated circuit 100 may comprise a substrate 10 and a top layer 20 arranged on the substrate 20. Each optical integrated circuit 100 may comprise a waveguide 25 buried inside a portion of the top layer 20 and extending along a longitudinal direction. The top layer 20 may comprise a cladding 27 surrounding the waveguide 25. For the ease of representation, the waveguide 25 was drawn using full lines, yet it is noted that this waveguide should be understood as buried inside the top layer 20. The waveguide 25 may be associated with a predetermined spot size which may be adapted by the edge coupler 30 to the spot size required by the external optical element. In the illustrated example, the external optical element is meant to be an optical fiber with a larger spot size than the predetermined spot size of the waveguide 25. In that sense, the edge coupler 30 is a spot size converter, converting the spot size between its input and its output. The edge coupler 30 may be arranged as well on the substrate 10. The edge coupler 30 may be arranged in a portion of the top layer 20 and may comprise an edge coupling waveguide 35 arranged to be coupled to the waveguide 25. The edge coupling waveguide 35 may be an inverse tapered waveguide aligned with the waveguide 25 and extending as well in the longitudinal direction. The taper of the tapered waveguide 35 may decrease in the longitudinal direction away from the waveguide 25, to increase the spot size.

The edge coupler 30 may extend above a cavity 32 provided in the substrate 10. The cavity 32 may be connected to the outside of the integrated circuit 100 via etching conduits 34 perforating the upper surface 20a of the top layer 20. The etching conduits 34 may debouch on the surface 20a on either side of the edge coupling waveguide 35. The etching conduits 34 may be regularly spaced. The edge coupling waveguide 25 may then be arranged in an area of the top layer 10, which is at least partially cantilevered above the cavity 32.

It is noted that although represented here with a buried waveguide, similar arrangements are available for other types of waveguides, like for instance a wire waveguide deposited on top of the top layer, as know by a person skilled in the art. As already mentioned above, for the ease of representation, the waveguides 25 and 35 were drawn using full lines, yet it is noted that these waveguides should be understood as buried inside the top layer 20. The waveguides 25 and 35 may be for instance a Si/SiN waveguide in a SiO2 cladding. Yet other alternatives would be evident to a person in the art.

The substrate 10 may be made of one of the following: a photo-sensitive substrate or a semiconductor wafer, preferably the substrate is made of one of the following: a polymer substrate, a glass substrate, a silicon wafer, silicon dioxide wafer, a lithium niobate wafer, a Gallium Arsenide wafer or an indium phosphide wafer, a ceramic substrate, a fiberglass substrate. A person skilled in the art would appreciate the benefits of each above type of substrate and associated use circumstances.

FIG. 2 illustrates a schematic top view of one of the optical integrated circuits 100 of FIG. 1. FIG. 2 shows how the conduits 34 are debouching on either side of the tapered waveguide 35 extending a longitudinal direction. The transverse direction marked A in the FIG. 2 shows the dicing direction. Another transverse direction, marked B in FIG. 1, may be perpendicular to the longitudinal direction of the waveguides 25 and 35, in other words parallel to the dicing direction A, and may further extend across two etching conduits 34 on either side of the edge coupling waveguide 35. Another longitudinal direction C may be parallel to the longitudinal direction of the waveguides 25 and 35 and may further extend across the etching conduits 34 debouching on the same side of the edge coupling waveguide 35 when seen from above, in other words on the same side of the cavity when seen from above.

FIG. 3 illustrates a cross section view of the optical integrated circuit of FIG. 2 along the direction B of FIG. 2. FIG. 3 shows a cavity 32 in the substrate 10 and the edge coupler 30 arranged above said cavity 32. Two recesses 33 etched around the two etching conduits 34, for example in a diamond shape, may be joining and may form together part of the cavity 32. The edge coupler 30 may comprise an optical membrane 31 arranged in between the etching conduits and comprising the edge-coupling waveguide 35. The optical membrane 31 may at least be partially separated from the remaining portion 36 of the top layer by the etching conduits 34. The optical membrane 31 may comprise the edge-coupling waveguide 35 and cladding 37 surrounding the edge-coupling waveguide 35. The cladding 37 may be made of the same material as the cladding of the waveguide 25. The etching conduits 34 may extend longitudinally through the top layer 20 and the substrate 10, perpendicular to the top surface 20a of the top layer.

FIGS. 4-6 illustrate cross section views of the integrated optical circuit 200 of FIG. 1 along the direction C of FIGS. 2 and 3 across the etching conduits 34 debouching on the same side of the edge coupling waveguide 35 when seen from above.

FIG. 4 shows etching conduits 34 spaced regularly along the longitudinal direction of the waveguides 25 and 35 (represented in broken lines because in another section plane). The recesses 33 etched in the substrate around the etching conduits 34 may be joining along the longitudinal direction and forming a cavity 32 extending along the longitudinal direction. Providing an integrated optical circuit 200 as in FIGS. 1 and 4 may represent the first step of a method according to an embodiment of the present invention.

FIG. 5 illustrates a subsequent step of a method for producing an optical integrated circuit 210, in which an adhesive 60 may be dispensed on to the optical integrated circuit 200. The adhesive 60 may be dispensed on top of the top of the optical membrane 31. According to an alternative, the adhesive 60 may be dispensed more widely on a portion of the top layer 20 containing the optical membrane 31 of the edge coupler 30. According to another alternative, the adhesive may be dispensed even more widely over the whole the top layer 20 containing both the waveguide 25 and the edge coupler 30 (i.e., containing the optical membrane 31). Concerning the last alternative, the adhesive 60 may in this way be fixedly attached the mechanical support 50 indirectly with the substrate 10 via a portion of the top layer 20 containing the waveguide 25. The adhesive 60 may be also dispensed to fill the cavity 32 via the etching conduits 34. The adhesive 60 may be an optical adhesive having an effective refractive index equal or smaller than the effective refractive index of the cladding 37 of the optical membrane 31. For example, the optical adhesive 60 may have a refractive index lower than 1.448 at a wavelength of 1550 nm. The optical adhesive may preferably be any one of the following adhesives: Norland Optical Adhesive 139, Norland Optical Adhesive 1348.

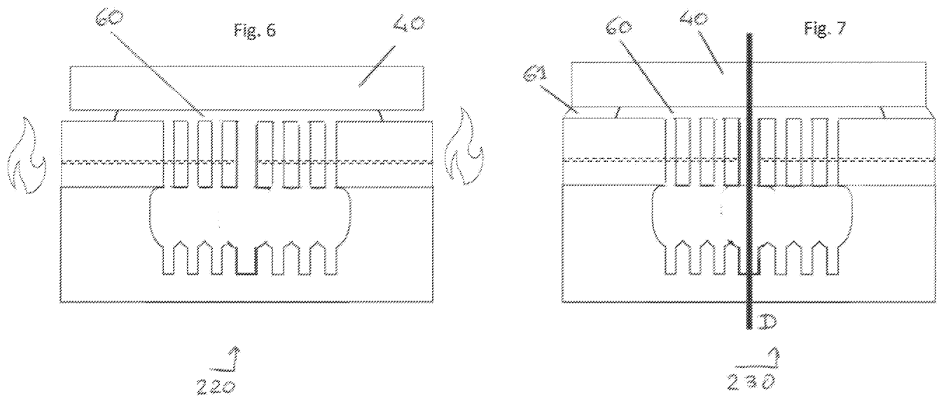

Next as illustrated in FIG. 6, a mechanical support 40 may be place on top of the adhesive 60 to fixedly attach the mechanical support 40 to the optical membrane 31 of the edge coupler 30, and more generally to the top surface 20a of the top layer 20. The mechanical support 40 may be made of glass or silicon. The mechanical support 40 may be arranged as a (rigid) sheet. The mechanical support 40 may have a mechanical strength adapted to allow dicing, grinding and/or polishing needed to obtain a a flat edge surface 50 for edge coupling the optical integrated circuit 300 with an external optical element 1. In other words, the mechanical support 40 and the optical adhesive 60 may bring to the optical integrated circuit 220 the mechanical strength necessary to protect the optical membrane 31 during dicing, grinding and/or polishing. It is noted that silicon may be particularly suited for further dicing operations. Next, curing may be performed to fixedly attach the mechanical support 40 to the optical membrane 31. The optical integrated circuit 220 obtained at this stage may then proceed to the next step described in FIG. 7.

According to an embodiment, when the optical adhesive is dispensed solely over the optical membrane 31 or a portion of the top layer, as illustrated in FIG. 7, a structural adhesive 61 may be dispensed in between the remaining exposed portion of the top layer 20 and the mechanical support 40. The structural adhesive 61 may further fixedly attach the mechanical support 40 indirectly with the substrate 10 via the portion of the top layer 20 containing the waveguide 25. Next, curing may be performed to fixedly attach the mechanical support 40 to the top layer 20.

Once the mechanical support 40 is fixed attached to the substrate 10 and the optical membrane 31, a dicing operation represented by a blade axis D may be performed, during which the optical integrated circuit 230 is cut in two. Yet the invention should not be regarded as limited to a dicing in two and a skilled person would understand that the idea behind the invention may be used for dicing multiple optical integrated circuits in general.

Once diced, an optical integrated circuit 230 of FIG. 7 may be grinded and polished to obtain the optical integrated circuit 300 according to the present invention comprising a flat surface 50 configured for edge coupling to the external optical element. FIG. 8 illustrates thus the final optical integrated circuit 300 obtained by a method according to the present invention. The flat surface 50 may be obtained by grinding/polishing the diced circuit of FIG. 7 up to an edge 38 of the membrane 31. From top to bottom, the mechanical support 40, the optical adhesive 60, the edge coupler 30, the adhesive filling the cavity 32 and the substrate 10 may jointly form the flat surface 50. The flat surface 50 extends in a plane perpendicular to the surface 120a of the top layer, and or the bottom surface of the substrate. During the grinding and polishing, a ledge 11 in the substrate 10 under the cavity 32, obtained when dicing the substrate 10 through the cavity 32, may be in particular removed. Similarly during the grinding and polishing, an overhang 41 in the mechanical support 40 obtained when dicing the optical integrate circuit may be removed. The removal of this ledge 11 and of the overhang 41 of the mechanical support 40 may allow edge coupling to the external element.

FIG. 9 illustrates a cross section of an embodiment in which the optical integrate circuit 300 of the invention is edge coupled to an optical fiber 1, comprising a core 1a and a cladding 1b. The flat surface 50 of the optical integrated circuit 100 may fixedly attached to a side facet of the optical fiber 1 via an adhesive 70, dispensed on the sides of the coupling of the optical integrated circuit 100 and the optical fiber 1. The core 1a of the optical fiber may extend along the longitudinal direction of the edge coupler. The core 1a may be aligned with the edge coupling waveguide 35, and the waveguide 25 by consequence.

FIG. 10 illustrate a cross section of another optical integrated circuit 100 used at the start of a method according to another embodiment of the present invention. The similar references will be used to describe similar features for the embodiments of FIGS. 10-12 as for the embodiments of FIGS. 4-8. The optical integrated circuit 100 of FIG. 10 may be obtained by dicing the optical integrated circuit 200 of FIG. 4. FIG. 10 illustrates then an optical integrated circuit 110 comprising an adhesive 60 dispensed around the whole edge coupler 30. Adhesive 60 may be dispensed above the optical membrane 31, in the etching conduits 34 and in the cavity 32, as well to the side of the optical membrane 31 and of the substrate 10.

Next as illustrated in FIG. 12, the mechanical support 40 may be placed above the adhesive 60 on top of the optical membrane 31 and cured to obtain an optical integrated circuit 120. Then in FIG. 12, like in FIGS. 6 and 7, the mechanical support 40 may be fixedly attached, using optionally an additional structural adhesive 61. An excess of adhesive 60 extending in the longitudinal direction further then an edge 41 of the mechanical support 40, and/or an edge 11 of the substrate 10 may then be optionally cut-off. Then the optical integrated circuit may be grinded and/or polished up to an edge 38 of the optical membrane 31, illustrated by the dotted line E. The final optical integrated circuit 300 obtained using this alternative method may then be the same one as in FIG. 8.

FIG. 13 illustrates a flow chart representing the steps of a method according to an embodiment of the present invention. The method comprises a step S10 for providing an optical integrated circuit 200 as illustrated in FIG. 4, or an optical integrated circuit 100 as illustrated in FIG. 10. The next step S20 comprises fixedly attaching the mechanical support 40 at an end thereof to the substrate 10 directly or indirectly via the top layer 20 and at an opposing end thereof to the optical membrane 31. The next step S30 comprises post-processing the optical integrated circuit obtained at step S20 such that the edge coupler 30, the substrate 10, and the mechanical support 40 jointly form a flat surface 50 configured for edge coupling with the external optical element 1.

FIGS. 14 and 15 illustrate flow charts representing some further steps of a method according to additional embodiments of the present invention.

As illustrated in FIG. 14, the step S20 of fixedly attaching a mechanical support may comprise:
a step S21 of dispensing an optical adhesive 60, preferably with a refractive coefficient inferior to the refractive coefficient of the optical membrane 31, preferably on top of the optical membrane and/or on the top layer and/or in the at least one cavity and/or surrounding the at least one optical membrane,
a step S22 of placing the mechanical support above the optical adhesive,
a step S23 of curing the optical adhesive 60,
a step S24 of dispensing a structural adhesive 61 in the remaining gap between the mechanical support 40 and the top layer,
and finally a step S25 of curing the structural adhesive 61.

As explained previously, in an alternative embodiment, only one adhesive may be used over the whole surface of the top layer 20 as both the optical and structural adhesive.

As illustrated in FIG. 15, the step S30 of post-processing the optical integrated circuit obtained at step S20 may comprises either a first step S31a of cutting the excess of adhesive in case of the embodiment of FIGS. 10, 12, or a step S31b of dicing the optical integrated circuit obtained at step S20 through a cavity to obtain two integrated circuits, followed by a step S32 of grinding and/or polishing the optical integrated circuit obtained at the previous steps S31a or S31b up to an edge of the optical membrane 31, to form the flat surface 50.

The disclosure comprises the following embodiments.
1. An optical integrated circuit (300) for edge coupling comprising:
   a substrate (10);
   a top layer (20) arranged on the substrate comprising a waveguide (25); and
   an edge-coupler (30) arranged on the substrate (10), the edge-coupler (30) comprising an optical membrane (31) extending above a cavity (32) in the substrate (10) and the edge-coupler (30) being configured for optically coupling the waveguide (25) to an external optical element (1);
   a mechanical support (40) fixedly attached at an end thereof to the substrate (10), either directly or indirectly via the top layer (20), and attached at an opposing end thereof to the optical membrane (31);
      wherein the edge coupler (30), the substrate (10), and the mechanical support (40) jointly form a flat surface (50) configured for edge coupling to the external optical element (1).
2. The optical integrated circuit according to the previous embodiment, wherein the mechanical support (40) is fixedly attached directly or indirectly to the substrate (10) and to the optical membrane (31) through at least one adhesive (60, 61).
3. The optical integrated circuit according to the previous embodiment, wherein the at least one adhesive (60,61) comprises an optical adhesive (60) and optionally a structural adhesive (61).
4. The optical integrated circuit according to any of the above embodiments, wherein the mechanical support (40) is fixedly attached to the optical membrane (31) through an optical adhesive (60), wherein the optical membrane (31) comprises an edge-coupling waveguide (35) and cladding (37) surrounding the edge-coupling waveguide (35), wherein the effective refractive index of the optical adhesive (60) is equal or smaller than an effective refractive index of the cladding (37) of the optical membrane (31).
5. Optical integrated circuit according to the previous embodiment, wherein the optical adhesive (60) is arranged on top of the at least one optical membrane (31) and/or in at least one cavity (32) under the at least one optical membrane (31) and/or surrounding the at least one optical membrane (31).
6. Optical integrated circuit according to any of the above embodiments, wherein the optical membrane (31) is any one of the following: a spot-size converter for connecting a waveguide in the Optical integrated circuit with an external fiber, a sensing membrane.
7. Optical integrated circuit according to any of the above embodiments, wherein the optical membrane (31) comprises a tapered waveguide (35) coupled to the waveguide (25) of the top layer (20).
8. Optical integrated circuit according to any of the above embodiments, wherein the waveguide (25) is a channel waveguide, preferably the waveguide (25) is any one of the following: a buried waveguide, a diffused waveguide, a wire waveguide, a strip loaded waveguide, an arrow waveguide, a rib waveguide, a slot waveguide, a metamaterial waveguide.
9. Optical integrated circuit according to any of the above embodiments, wherein the substrate is made of one of the following: a photo-sensitive substrate or a semiconductor wafer, preferably the substrate is made of one of the following: a polymer substrate, a glass substrate, a silicon wafer, silicon dioxide wafer, a lithium niobate wafer, a Gallium Arsenide wafer or an indium phosphide wafer, a ceramic substrate, a fiberglass substrate, an organic substrate.
10. Optical integrated circuit according to any of the above embodiments, wherein the optical membrane is made of one of the following: a Si/SiN waveguide in a SiO2 cladding, doped SiO2 waveguide in a SiO2 cladding, polymer waveguide in a polymer cladding, waveguide and cladding composed of a binary combination of materials from Groups III and V of the periodic table, waveguide and cladding composed of a ternary combination of materials from Groups III and V of the periodic table, waveguide and cladding composed of a quaternary combination of materials from Groups III and V of the periodic table, or other materials supporting a high-index-contrast waveguide.
11. Optical integrated circuit according to any of the above embodiments, wherein the mechanical support is made of one of the following: glass, silicon, polymer, ceramic, fiberglass, a binary combination of materials from Groups III and V of the periodic table, a ternary combination of materials from Groups III and V of the periodic table, a quaternary combination of materials from Groups III and V of the periodic table, or another mechanically compatible material.
12. Method for producing an optical integrated circuit (300) for edge coupling, the method comprising:
   providing (S10) an optical integrated circuit (100, 200) with a substrate (10), a top layer (20) arranged on the substrate (10) comprising a waveguide (25) and an edge-coupler (30) arranged on the substrate (10), the edge coupler (30) being configured for optically coupling the waveguide (25) to an external optical element (1) and comprising an optical membrane (31) extending above a cavity (32) in the substrate (10),
   fixedly attaching (S20) a mechanical support (40) at an end thereof to the substrate (10), directly or indirectly via the top layer (20), and at an opposing end thereof to the optical membrane (31),
   post-processing (S30) the circuit obtained at the previous step such that the optical membrane (31), the substrate (10), and the mechanical support (40) jointly form a flat surface (50) configured for edge coupling with the external optical element.
13. The method of the previous claim, wherein providing (S10) an assembly with a substrate, a waveguide and an edge-coupler comprises etching at least one cavity in the substrate (10) under the edge coupler (30), to obtain an optical membrane (31) at least partially extending above the at least one cavity (32) in the substrate (10).
14. The method of any of the previous method embodiments, wherein fixedly attaching (S20) a mechanical support comprises dispensing an optical adhesive (S21) and placing the mechanical support (S22) above the optical adhesive, and optionally curing the optical adhesive.
15. The method of the previous embodiments, wherein dispensing an adhesive (S210) comprises dispensing an optical adhesive on top of the optical membrane and/or on the top layer, and/or in the at least one cavity and/or surrounding the at least one optical membrane.
16. The method of any one of the last two previous method embodiments, wherein fixedly attaching (S20) a mechanical support (40) comprises dispensing a structural adhesive (S24) in the remaining gap between the mechanical support and the top layer, and optionally curing the structural adhesive (S25).
17. The method of any of the previous method embodiments, wherein post-processing (S30) comprises dicing (S31b) to obtain two integrated circuits.
18. The method of any of the previous method embodiments, wherein post-processing (S30) comprises preferably cutting off (S31a) the excess of optical adhesive up to an edge (41) of the mechanical support (40) and/or an edge (11) of the substrate (10).
19. The method of any one of the previous two embodiments, wherein post-processing (S30) further comprises grinding and/or polishing (S32) an edge of the optical integrated circuit obtained at the previous step up to an edge (38) of the optical membrane (31) to obtain a flat edge surface (50) for edge coupling the optical integrated circuit (300) with an external optical element (1).

Whilst the principles of the invention have been set out above in connection with specific embodiments, it is understood that this description is merely made by way of example and not as a limitation of the scope of protection which is determined by the appended claims.

1. An optical integrated circuit for edge coupling comprising:
a substrate;
a top layer arranged on the substrate comprising a waveguide; and
an edge-coupler arranged on the substrate, the edge-coupler comprising an optical membrane extending above a cavity in the substrate and the edge-coupler being configured for optically coupling the waveguide to an external optical element;
the optical integrated circuit being characterized in that it further comprises
a mechanical support fixedly attached at an end thereof to the substrate, at least one of directly and indirectly via the top layer, and attached at an opposing end thereof to the optical membrane;
wherein the mechanical support is fixedly attached, at least one of directly and indirectly to the substrate and to the optical membrane through at least one adhesive;
wherein the at least one adhesive comprises an optical adhesive, wherein the optical adhesive is arranged in the cavity under the at least one optical membrane;
wherein the edge coupler, the substrate the optical adhesive and the mechanical support jointly form a flat surface configured for edge coupling to the external optical element.

2. The optical integrated circuit according to claim 1, wherein the at least one adhesive further comprises a structural adhesive.

3. The optical integrated circuit according to claim 1, wherein the mechanical support is fixedly attached to the optical membrane through the optical adhesive, wherein the optical membrane comprises an edge-coupling waveguide and cladding surrounding the edge-coupling waveguide, wherein the effective refractive index of the optical adhesive is equal or smaller than an effective refractive index of the cladding of the optical membrane.

4. The optical integrated circuit according to claim 2, wherein the optical adhesive is arranged at least one of on top of the at least one optical membrane and surrounding the at least one optical membrane.

5. The optical integrated circuit according to claim 1, wherein the optical adhesive is arranged to fill the cavity.

6. The optical integrated circuit according to claim 1, wherein the optical membrane is any one of the following: a spot-size converter for connecting a waveguide in the Optical integrated circuit with an external fiber, a sensing membrane.

7. The optical integrated circuit according to claim 1, wherein the optical membrane comprises a tapered waveguide coupled to the waveguide of the top layer.

8. The optical integrated circuit according to claim 1, wherein the waveguide is a channel waveguide.

9. The optical integrated circuit according to claim 1, wherein the substrate is made of one of the following: a photo-sensitive substrate or a semiconductor wafer.

10. The optical integrated circuit according to claim 1, wherein the optical membrane is made of one of the following: a Si/SiN waveguide in a SiO2 cladding, doped SiO2 waveguide in a SiO2 cladding, polymer waveguide in a polymer cladding, waveguide and cladding composed of a binary combination of materials from Groups III and V of the periodic table, waveguide and cladding composed of a ternary combination of materials from Groups III and V of the periodic table, waveguide and cladding composed of a quaternary combination of materials from Groups III and V of the periodic table, or other materials supporting a high-index-contrast waveguide.

11. The optical integrated circuit according to claim 1, wherein the mechanical support is made of one of the following: glass, silicon, polymer, ceramic, fiberglass, a binary combination of materials from Groups III and V of the periodic table, a ternary combination of materials from Groups III and V of the periodic table, a quaternary combination of materials from Groups III and V of the periodic table, or another mechanically compatible material.

12. The optical integrated circuit according to claim 1, wherein the mechanical support is formed as a sheet overlaying the top layer; and wherein the mechanical support has a mechanical strength enabling grinding/polishing processes for obtaining the flat surface for edge coupling to the external optical element.

13. (canceled)

14. A method for producing an optical integrated circuit (300) for edge coupling, the method comprising:
providing an optical integrated circuit with a substrate, a top layer arranged on the substrate comprising a waveguide and an edge-coupler arranged on the substrate, the edge coupler being configured for optically coupling the waveguide to an external optical element and comprising an optical membrane extending above a cavity in the substrate,
fixedly attaching a mechanical support at an end thereof to the substrate, directly or indirectly via the top layer, and at an opposing end thereof to the optical membrane, wherein fixedly attaching a mechanical support comprises dispensing an optical adhesive and placing the mechanical support above the optical adhesive, wherein dispensing the optical adhesive comprises dispensing the optical adhesive in the cavity;
post-processing the circuit obtained at the previous step such that the optical membrane, the substrate, the optical adhesive and the mechanical support jointly form a flat surface configured for edge coupling with the external optical element.

15. The method of claim 14, wherein providing an assembly with a substrate, a waveguide and an edge-coupler comprises etching at least one cavity in the substrate under the edge coupler, to obtain an optical membrane at least partially extending above the at least one cavity in the substrate.

16. The method of claim 14, wherein placing the mechanical support above the adhesive comprises overlaying the mechanical support arranged as a sheet over the optical adhesive and the top layer.

17. The method of claim 14, wherein fixedly attaching a mechanical support further comprises curing the optical adhesive.

18. The method of claim 14, wherein dispensing an optical adhesive comprises at least one of dispensing an optical adhesive on top of the optical membrane and/or on the top layer and/or surrounding the at least one optical membrane, and filling the cavity with the optical adhesive.

19. (canceled)

20. The method of claim 18, wherein fixedly attaching a mechanical support further comprises dispensing a structural adhesive in the remaining gap between the mechanical support and the top layer, and optionally curing the structural adhesive.

21. The method of claim 14, wherein post-processing comprises at least one of dicing to obtain two integrated circuits, cutting off the excess of optical adhesive up to an edge of the mechanical support and/or an edge of the substrate, grinding and/or polishing an edge of the optical integrated circuit obtained at a previous step up to an edge of the optical membrane to obtain a flat edge surface for edge coupling the optical integrated circuit with an external optical element.

22-23. (canceled)
